(19) United States
(12) Patent Application Publication
(10) Pub. No.: US 2012/0132702 A1
(43) Pub. Date: May 31, 2012

(54) Test Assist Device

(75) Inventors: Qiao Yuan, Chung-Ho (TW); Coast Zhou, Chung-Ho (TW); Ching-Feng Hsieh, Wanhua District (TW)

(73) Assignee: Askey Computer Corporation, Chung-Ho (TW)

(21) Appl. No.: 12/962,204

(22) Filed: Dec. 7, 2010

(30) Foreign Application Priority Data
Nov. 26, 2010 (TW) 99140957

(51) Int. Cl. G06F 17/00; G06F 15/00

(52) U.S. Cl. 235/375; 702/188

(57) ABSTRACT

A test assist device includes: a network function module having a network port that is connectible to a network device; a control module connected to the network function module and having a processing unit and a transmission port electrically connectible to an input unit for receiving from the input unit at least one of basic test data and test result messages of an object, the processing unit transmitting the received at least one of the basic test data and the test result messages via the network function module to the network device; and an output module connected to the control module and having a basic status prompt unit and a test result prompt unit, the basic status prompt unit having a plurality of LEDs for displaying corresponding information corresponding to the basic test data, the test result prompt unit displaying corresponding information corresponding to the test result messages.

### BACKGROUND OF THE INVENTION

1. Field of the Invention

This invention relates to test assist devices, and, more particularly, to a test assist device that displays test information and uploads the test information to a network device.

2. Description of Related Art

With the rapid development of electronic technology and the trend of market competition, electronic products, such as computers, mobile phones and electronic appliances, are designed to have a variety of functions. In order to ensure that the products function normally, the products are to be tested before sold to consumers.

According to the prior art, a test computer that is installed with a test program is located in a test station, and test personnel stay in the test station and test the functions of an electronic product with a test machine. During the test process, the personnel have to input the test result messages of the electronic product, and stores the test result messages in the test computer temporarily. After all of the functions of the electronic product are tested, the stored test result messages are uploaded by the test program via the network system to a central host.

However, the above test method suffers some problems. The test computer that is expensive has to be used to collect the test results. The test hardware cost may be reduced by reducing the number of test stations, which, however, also reduces the working efficiency as a whole. If an electronic product has too many types of functions, the test computer is occupied for a long time, because the test result messages stored for being uploaded to the central host are established on the basis of an electronic product corresponding to a test result. If the electronic product is tested to be abnormal, the personnel, after opening an electronic file of test results of the abnormal electronic product, still have to search the contents of the electronic file of the test results for the abnormal function item of the electronic product. Because the electronic file of test results has poor readability, the working efficiency of subsequent processes, such as maintenance or debugging, is greatly reduced.

### SUMMARY OF THE INVENTION

In view of the above-mentioned problems of the prior art, the present invention provides a test assist device.

The test assist device receives from an input unit at least one of basic test data and test result messages of an object, and transmits the at least one of the basic test data and the test result messages to a network device. The test assist device includes: a network function module having a network port connectible to the network device; a control module connected to the network function module and having a processing unit and a transmission port electrically connectible to the input unit for receiving from the input unit the at least one of the basic test data and the test result messages, the processing unit transmitting the received at least one of the basic test data and the test result messages via the network function module to the network device; and an output module connected to the control module and having a basic status prompt unit and a test result prompt unit, the basic status prompt unit comprising a plurality of light emitting diodes (LED) for displaying corresponding information corresponding to the basic test data, the test result prompt unit being for displaying corresponding information corresponding to the test result messages.

In an embodiment of the present invention, the test assist device further includes barcodes of the objects that indicate the basic test data, and the input unit is a barcode scanner for reading the barcodes of the object and barcodes of the test assist device; the basic test data include one of a standby statue in which the test assist device is operating, an actuating status in which the test assist device is operating, a product type number of the object, a test station where the test assist device stays, personnel who execute a test process, and a test machine that cooperates with the test assist device; and the test result messages include messages that indicate that whether the object is normal or abnormal.

It is known from the above that personnel stayed in a test station may perform a scanning process by using the test assist device of the present invention, without needing the type of test data on a keyboard. Therefore, the time required by the test process is greatly reduced.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of a test assist device according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be revised without departing from the spirit of the present invention.

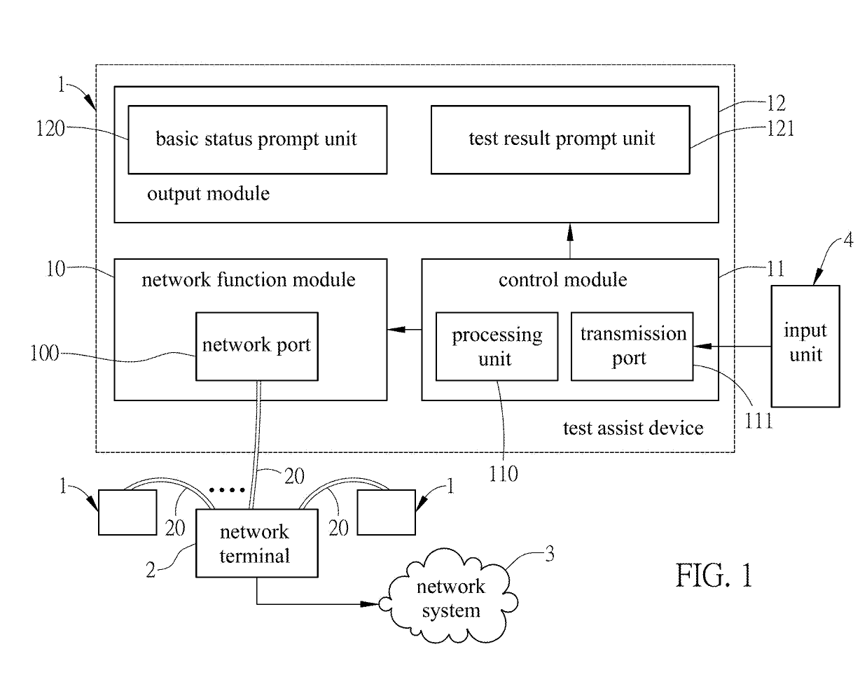

A test assist device of the present invention may help personnel that execute a test process to provide test result messages of an object to a central host quickly and conveniently. In particular, the personnel need not type the test result messages on a keyboard, and the central host can still obtain the test result messages. Please refer to FIG. 1, which is a functional block diagram of a test assist device 1 according to the present invention. The test assist device 1 comprises a network function module 10, a control module 11, and an output module 12.

The network function module 10 has a network port 100 connected via a network line 20 to a network terminal 2. The network terminal 2 connects the test assist device 1 to a network system 3. The network system 3 is a test network connected to the central host. For example, the network system 3 may be an Intranet or Internet that may provide a test environment for a product.

Note that a plurality of the test assist devices 1 may be installed, according to the test environment such as the number of test stations. However, each of the test assist devices 1 has its dedicated IP address, in order to avoid IP address confliction and ensure that the test information may be uploaded to the central host. In addition to the network terminal 2, the network line 20 may be connected to other network devices, as long as the network devices may receive and transmit data. For example, the network device may also act as the central host and receive the test data uploaded by the test assist device 1.

The control module 11 is connected to the network function module 10. The control module 11 has a processing unit 110 and a transmission port 111. The processing unit 110 is a control core of the test assist device 1, and may be a microcontroller. The transmission port 111 is electrically connectible to the input unit 4. The transmission port 111 may be a serial port such as an RS-232 interface. The transmission port 111 is electrically connectible to the input unit 4. The input unit 4 may be a barcode scanner. Test information that are to be uploaded to the central host may be input to the input unit 4. The test information are at least one of basic test data and test result messages.

The output module 12 is connected to the control module 11. The output module 12 has a basic status prompt unit 120 and a test result prompt unit 121. The basic status prompt unit 120 and the test result prompt unit 121 comprise display units that have a prompting function, such as LEDs, a seven-segment display or a liquid crystal display. The output module 12 may thus display the test information input by the input unit 4 to the control module 11, such that personnel that execute a test process may identify whether the test information that are to be uploaded to the central hole are correct.

Before the test assist device 1 uploads the test information to the central host, an IP address setting process must be performed on the network function module 10. In details, the network function module 10 is connected via the network port 100 to a general computer (not shown); ipconfig is input to an operating system (e.g., DOS operating system) of the computer to check the IP address of the computer; the terminal setting of the computer is actuated to set the port to which the test assist device 1 is connected, e.g., the transmission port 111 of the control module 11. The settings include a use connection as a connection port “COM1” and setting the contents of the connection port “COM1”, the contents include bits transmitted per second and data bits. Further, the test assist device 1 is set to have a dedicated IP address on the test station, and the IP address of the central host is set as well.

After the above-mentioned parameters are set, the test information may be uploaded via the test assist device 1 of the present invention to the central host. In order to clearly describe a process during which the test assist device 1 of the present invention uploads the test information to the central host, an embodiment is illustrated as follows. In the embodiment, the input unit 4 is a barcode scanner, the basic status prompt unit 120 comprises a plurality of LEDs, and the test result prompt unit 121 comprises a seven-segment display.

In order to cooperate with the test assist device 1 of the present invention, barcodes are installed on the test assist device 1. The barcodes indicate that the test assist device 1 is operating in a standby status, that the test assist device 1 is operating in an actuating status, a product type number of the object, a test station where the test assist device 1 stays, personnel who execute a test process, a test machine that cooperates with the test assist device 1, and whether the object is normal or abnormal. By using the barcode scanner to read the barcodes of the object and the test assist device 1, personnel may input the test information to the test assist device 1 obtained during the test process, and the LEDs or the seven-segment display may operate according to the test information. Note that the barcodes may be installed on other devices and read by the barcode scanner.

After connecting the test assist device 1 of the present invention to the network line 20 that may communicate with the network system 3, connecting the test assist device 1 to the barcode scanner, and providing power to the test assist device 1 and the barcode scanner, personnel may find out corresponding barcodes for the barcode scanner to read according to the basic test data, such as the test station where the test assist device 1 stays, the status in which the test assist device 1 is operating (e.g., standby status or actuating status), the test machine that cooperates with the test assist device 1 and the product type number of the object. After the processing unit 110 receives the barcodes (i.e., the basic test data), the LEDs are controlled to emit light in a manner that only one of the LEDs blinks, only one of the LEDs emits light constantly, at least two of the LEDs blink or at least two of the LEDs emit light constantly. After the barcode scanner reads the barcodes, the processing unit 110 controls the network function module 10 to transmit the barcodes that are the basic test data to the central host via the network line 20 that is connected to the network port 100.

Thereafter, the personnel may obtain the test result messages of the product (e.g., normal or abnormal) from the test machine that cooperates with the test assist device 1, and find out the corresponding barcodes for the barcode scanner to read. After receiving the barcodes that are the test result messages, the processing unit 110 controls the seven-segment display to operate. If the seven-segment display displays “0”, the test result is normal. If the seven-segment display displays “7”, the test result is abnormal. After the barcode scanner reads the barcodes, the processing unit 110 controls the network function module 10 to upload the test result messages via the network line 20 that is connected to the network port 100 to the central host.

In conclusion, the test assist device of the present invention reduces the computer hardware cost, because the computer that is installed with a test program does not need to upload an electronic file of the test result to the central host. Since in the present invention the test contents that are uploaded to the central host include the status test data and the test result messages, corresponding test result messages may be transmitted individually based on various function items of the product. Therefore, the personnel do not need to search the electronic file of the test result for the abnormal function items of the product. Besides, the personnel who stay at the test station do not need to type test results and upload commands. With the test assist device of the present invention, the personnel may perform the scanning process only, such that the time required for test the object is reduced.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A test assist device for receiving from an input unit at least one of basic test data and test result messages of an object, and transmitting the at least one of the basic test data and the test result messages to a network device, the test assist device comprising:
a network function module having a network port connectible to the network device;
a control module connected to the network function module and having a processing unit and a transmission port electrically connectible to the input unit for receiving from the input unit the at least one of the basic test data and the test result messages, wherein the processing unit transmits the received at least one of the basic test data and the test result messages via the network function module to the network device; and
an output module connected to the control module and having a basic status prompt unit and a test result prompt unit, the basic status prompt unit comprising a plurality of light emitting diodes (LED) for displaying corresponding information corresponding to the basic test data, the test result prompt unit being for displaying corresponding information corresponding to the test result messages.

2. The test assist device of claim 1, wherein the transmission port is a serial port.

3. The test assist device of claim 1, further comprising barcodes of the objects that indicate the basic test data, wherein the input unit is a barcode scanner for reading the barcodes of the object and barcodes of the test assist device.

4. The test assist device of claim 3, wherein the LEDs of the basic status prompt unit emit light according to the barcodes of the test assist device read by the barcode scanner in a manner that only one of the LEDs blinks, only one of the LEDs emits light constantly, at least two of the LEDs blink, or at least two of the LEDs emit light constantly.

5. The test assist device of claim 4, wherein the basic test data corresponding to each of the barcodes includes one of a standby status in which the test assist device is operating, an actuating status in which the test assist device is operating, a product type number of the object, a test station where the test assist device stays, personnel who execute a test process, and a test machine that cooperates with the test assist device.

6. The test assist device of claim 3, wherein the test result prompt unit comprises a seven-segment display that emits light according to the barcodes of the object read by the barcode scanner.

7. The test assist device of claim 6, wherein the test result messages include messages that indicate whether the object is normal or abnormal.

8. The test assist device of claim 7, wherein the seven-segment display's displaying “0” indicates that the object is normal.

9. The test assist device of claim 7, wherein the seven-segment display's displaying “7” indicates that the object is abnormal.
